(19) United States
(12) Patent Application Publication
(10) Pub. No.: US 2026/0338602 A1
(43) Pub. Date: Oct. 29, 2026

(54) OPTICAL SPECTROMETER AND MANUFACTURING METHOD

(71) Applicant: Bruker Optics GmbH & Co. KG, Ettlingen (DE)

(72) Inventor: Stephan LÜTTJOHANN, Karlsruhe (DE)

(73) Assignee: Bruker Optics GmbH & Co. KG, Ettlingen (DE)

(21) Appl. No.: 19/641,944

(22) Filed: Apr. 8, 2026

(30) Foreign Application Priority Data
Apr. 9, 2025 (DE) 102025113979.2

(51) Int. Cl. G01J 3/28; G01J 3/02; G01J 3/14; G01J 3/18

(52) U.S. Cl. CPC G01J 3/28; G01J 3/0208; G01J 3/021; G01J 3/14; G01J 3/18

(57) ABSTRACT

An optical spectrometer with an optical axis includes an entrance aperture in an aperture plane perpendicular to the optical axis. A collimating optical system has at least two optical elements. The collimating optical system has, perpendicular to the optical axis, in a dispersion direction x, a first focal length and a first focal plane and, in a non-dispersion direction y perpendicular thereto, a second focal length and a second focal plane. Included is a dispersive element and a focusing optical system for focusing the light spectrally split by the dispersive element. The first focal length of the collimating optical system and the second focal length of the collimating optical system differ from each other. The first focal plane and the second focal plane of the collimating optical system coincide with the aperture plane.

### CROSS-REFERENCE TO RELATED APPLICATIONS

This application claims priority to German Patent Application No. DE 10 2025 113 979.2, filed Apr. 9, 2025, the entire contents of which are hereby incorporated in full by this reference.

### DESCRIPTION

### Field of the Invention

The invention relates to an optical spectrometer with an optical axis, comprising an entrance aperture for limiting light entering the spectrometer along the optical axis, wherein the entrance aperture is arranged in an aperture plane perpendicular to the optical axis; a collimating optical system with at least two optical elements for collimating the light passing through the entrance aperture, wherein the collimating optical system has, perpendicular to the optical axis, in a dispersion direction x, a first focal length fAx and a first focal plane and, in a non-dispersion direction y perpendicular thereto, a second focal length fAy and a second focal plane; a dispersive element for spectrally splitting light incident on the dispersive element in the dispersion direction x; a focusing optical system for focusing the light spectrally split by the dispersive element; and a detector for detecting the focused light in a detector plane, wherein the focusing optical system has, perpendicular to the optical axis, in the dispersion direction x, a first focal length fBx and a first focal plane and, in the non-dispersion direction y, a second focal length fBy and a second focal plane.

### Background of the Invention

In dispersive spectrometers, light from an entrance aperture hits the collimating optical system, which then directs the collimated light further onto the dispersive element. From the dispersive element, light of different wavelengths is deflected to varying degrees in the dispersion direction, resulting in a spectral splitting in the dispersion direction of the light striking the dispersive element. The focusing optical system captures this light and focuses the different wavelengths coming from different directions onto different parts of the detector.

The focal lengths of the collimating optical system and the focusing optical system are chosen based upon spectral properties. However, the focal lengths chosen in this way, which were optimized for the dispersion direction, also have a direct effect on the properties of the spectrometer in the non-dispersion direction in conventional spectrometers, such as the size of the image of the entrance aperture in the non-dispersion direction or the size of the required optical components in the non-dispersion direction. This leads to disadvantages in conventional spectrometers and often requires bulky components.

The first focal length fAx of the collimating optical system and the second focal length fAy of the collimating optical system are thus different from one another, and the first focal plane of the collimating optical system and the second focal plane of the collimating optical system coincide with the aperture plane.

Dispersive spectrometers are known from [US659] and [US413] and feature collimating and focusing optical systems with freeform mirrors. The use of freeform mirrors is intended to optimize image quality.

[US807] discloses an imaging spectrometer in which an anamorphic mirror is used to correct imaging errors occurring at oblique angles of incidence and to ensure that the mirror has the same focal length in the dispersion direction and in the non-dispersion direction.

[US088] discloses a grating spectrometer having a mirror for collimation in front of a grating and a mirror for focusing behind the grating and a sensor on which a cylindrical lens is directly applied. This is intended to correct imaging errors on the one hand, but also to compress the generated image in the non-dispersion direction on the sensor. This means that the entrance aperture is imaged onto the detector at different magnifications in the dispersion direction and the non-dispersion direction. A disadvantage of this device is that the image quality is characterized by astigmatism. Light points from the entrance aperture are therefore imaged onto vertical lines on the sensor.

[US772] describes an anamorphic spectrometer for a remote sensing system. The collimated light is focused onto a slit in only one dimension using an anamorphic mirror. In the other dimension, the light remains collimated. Behind the slit, the light is completely collimated again by another anamorphic mirror and directed onto a grating. The beams of different wavelengths, diffracted in different directions by the grating, are then focused on a detector array. The spectrometer described in [US772] is not suitable for imaging light with a homogeneous numerical aperture from an entrance aperture (as is the case, for example, with light from a waveguide with diameter D and numerical aperture NA or with light from a microscope focused onto the entrance slit of the spectrometer via a tube lens).

[US140] discloses a spectrometer in which a focused beam is directed onto a curved grating instead of a collimated beam onto a planar grating. The described system attempts to optimize the imaging properties of the spectrometer (entrance aperture to detector) by exploiting symmetry properties. The curved grating not only ensures the spectral splitting of the light, but also contributes to the imaging properties. The optimization shown works well for a stationary system. If, however, it is desired that other spectral ranges also be imaged onto the detector, the grating would have to be rotated, which destroys the symmetry and greatly reduces the imaging properties. Switching to a different grating with a different furrow density is also not easily achievable.

It is not possible to reduce the height of the optical components in any of the spectrometers described above.

[WO584] describes a spectrometer for measuring distances and/or thicknesses of a measurement object. The spectrometer comprises, in the collimating optics, a first cylindrical lens that collimates light coming from the entrance aperture orthogonal the direction of the detector row, as well as a second cylindrical lens that is arranged behind the first cylindrical lens and collimates the light coming from the entrance aperture in the direction of the detector row. A disadvantage of this arrangement is that the first cylindrical lens must be positioned at a fixed distance from the entrance aperture, which means that the optical design of the spectrometer cannot be configured flexibly.

### SUMMARY OF THE INVENTION

### Object of the Invention

The object of the invention is to propose a spectrometer and a method for manufacturing a spectrometer that has a high spectral resolution and can be built in a compact form.

### DESCRIPTION OF THE INVENTION

This object is achieved according to the invention by an optical spectrometer according to claim 1 and by a method for manufacturing an optical spectrometer according to claim 12.

In the spectrometer according to the invention, the first focal length fAx of the collimating optical system and the second focal length fAy of the collimating optical system differ from each other. Furthermore, according to the invention, the first focal plane of the collimating optical system and the second focal plane of the collimating optical system coincide with the aperture plane.

The collimating optical system therefore has different focal lengths in the dispersion direction x and in the non-dispersion direction y, but the focal points in the dispersion direction x and in the non-dispersion direction y coincide. To achieve this, optical elements with different optical powers in the dispersion direction x and in the non-dispersion direction y are preferably used for the collimating optical system. The coincidence of the focal planes with the aperture plane is achieved by appropriate selection and positioning of the optical elements (and thus the principal planes) of the collimating optical system.

According to the invention, both the focal length of the first optical element and the focal length of the second optical element of at least one of the optical elements of the collimating optical system are finite, where the first element focal length differs from the second element focal length of this optical element. That is, if the above condition is to hold for the nth optical element, then the following must hold: fAnx≠∞, fAny≠∞, fAnx≠fAny, (n≥1).

The spectrometer according to the invention allows for additional degrees of freedom in the selection of different focal lengths, which allows the height and resolution of the spectrometer to be optimized.

For the image quality in the dispersion direction or perpendicular to the dispersion direction, it is advantageous if the optical power of the collimating optical system in the dispersion direction or perpendicular to the dispersion direction is not provided by a single optical element but is distributed across both optical elements. According to the invention, the optical power of the collimating optical system is therefore distributed across both optical elements in at least one direction, i.e., both optical elements contribute to the collimation in this direction (i.e., the focal lengths fA1x and fA1y of the individual optical elements of the collimating optical system are each finite and/or the focal lengths fA2x and fA2y of the individual optical elements of the focusing optical system are each finite). This also allows the collimating optical system to be designed more compactly. For long focal lengths and small diameters of the collimated beam in the dispersion direction or in the direction perpendicular to the dispersion direction—i.e., a large f-number (f/#=f/D) in this direction, it may also be sufficient for a single optical element to provide the entire optical power in this direction. In the latter case, one focal length of the element would then be infinite.

The optical elements each have a first element focal plane perpendicular to the optical axis in the dispersion direction x and a second element focal plane in the non-dispersion direction y, wherein the first element focal plane and the second element focal plane lie outside the aperture plane. If the optical power is provided by more than one optical element, the desired focal lengths fAx and fAy of the collimating optical system can be achieved by selecting the positions of the two optical elements and their element focal lengths fA1x, fA1y, fA2x, fA2y. The principal planes thus do not lie at the location of the optical elements, so that the distance of the optical elements from the entrance aperture does not have to correspond to the focal lengths fAx and fAy. This has the advantage that the positioning of the optical elements can be designed more freely and the optical system as a whole can also be realized in a more compact manner.

In principle, combinations of positive and negative focal lengths are possible for both the collimating optical system A and the focusing optical system B.

The spectrometer according to the invention can be an imaging or non-imaging spectrometer. In both variants, an image of the entrance aperture is generated in the detector plane for each wavelength present in the light. The image quality influences the ability to separate the different wavelengths present in the light on the detector. Furthermore, if it is possible to distinguish from which region the light from the entrance aperture comes in the non-dispersion direction y, it is called an imaging spectrometer.

A reflection or transmission grating or a prism preferably serves as the dispersive element. A detector array is preferably used as the detector.

The first focal length fBx of the focusing optical system and the second focal length fBy of the focusing optical system can, in principle, be the same in the context of the invention (uniform focal length of the focusing optical system).

In a particularly preferred embodiment, however, the focusing optical system also comprises at least two optical elements, and the first focal length fBx of the focusing optical system and the second focal length fBy of the focusing optical system differ from each other. In this embodiment, the first focal plane and the second focal plane of the focusing optical system coincide with the detector plane. In this embodiment, the focusing optical system also has different focal lengths in the dispersion direction x and in the non-dispersion direction y (double anamorphic spectrometer), but the focal points in the dispersion direction x and in the non-dispersion direction y coincide. To achieve this, optical elements are used for the focusing optical system that have different optical power in the dispersion direction x and in the non-dispersion direction y. The coincidence of the focal planes with the detector plane is achieved by appropriate selection and positioning of the optical elements (and thus the principal planes) of the focusing optical system.

The advantage of this particularly preferred embodiment is that the four focal lengths fBx, fAx, fAy, and fBy are independent of each other. Each of these focal lengths is associated with certain properties of the spectrometer, which are outlined below: fBx (first focal length of the focusing optical system): together with the dispersion strength of the dispersive element and the detector size in the dispersion direction, this determines the spectral range accessible in a measurement, fAx (first focal length of the collimating optical system): has an influence, together with the size of the entrance aperture in x direction, on the spectral resolving power λ/Δλ; significantly determines the size of the spectrometer in dispersion direction x. fAy (second focal length of the collimating optical system): significantly determines the size of the spectrometer in the non-dispersion direction y; together with the second focal length fBy of the focusing optical system, this determines the imaging ratio in non-dispersion direction y.

Together with fBy, it influences the optical throughput fBy (second focal length of the collimating optical system): together with the second focal length fAy of the collimating optical system, determines the imaging ratio in non-dispersion direction y; together with the second focal length fAy of the collimating optical system, this influences the optical throughput.

As can be seen from the overview, some properties depend upon only one focal length (spectral range, height in the non-dispersion direction), others upon two focal lengths (imaging ratio in the non-dispersion direction, throughput).

In contrast, with a conventional spectrometer, further properties are linked together, since in these spectrometers fAx=fAy and fBx=fBy.

With fAx=fAy, it follows that, for a conventional spectrometer, the height in the non-dispersion direction, the height in the dispersion direction, the resolution, and the throughput are linked.

With fBx=fBy, it follows that the spectral range accessible during a measurement, the imaging ratio in the non-dispersion direction, and the optical throughput are linked in a conventional spectrometer.

These links are not present in a spectrometer according to this invention in a particularly preferred embodiment.

Preferably, the first focal length fAx of the collimating optical system is greater than the second focal length fAy of the collimating optical system: fAx>fAy. This has the effect that the width of the light beam in the non-dispersion direction y is smaller after passing through the collimating optical system than in the dispersion direction x. This allows the optical elements and the dispersive element to be smaller in the non-dispersion direction y than in the dispersion direction x, thus enabling a more compact design in the non-dispersion direction y without compromising the spectrometer's etendue (light throughput). The spectrometer can therefore be made flatter. Furthermore, smaller optical elements offer a cost advantage.

Preferably, fAx>1.1*fAy. The first focal length fAx of the collimating optical system and the second focal length fAy of the collimating optical system differ significantly from each other, so that a significant effect in the size reduction of the optical elements can be achieved. In a particularly preferred embodiment, fAx>1.4*fAy.

In a special embodiment, the first focal length fAx of the collimating optical system is greater than or equal to the first focal length fBx of the focusing optical system: fAx>fBx. In this case, the entrance aperture is either imaged 1:1 or reduced in size in the dispersion direction x (spectral dimension). In the case of a reduced-size image, an improved optical resolution is achieved.

Preferably, the second focal length fAy of the collimating optical system is equal to the second focal length fBy of the focusing optical system (fAy=fBy). The entrance aperture is then imaged 1:1 in the non-dispersion direction y (local dimension). This is particularly advantageous when the light from an upstream optical system (e.g., a microscope) is to be spectrally analyzed, and the magnification of the upstream optical system is not to be changed further.

Alternatively, by choosing the ratio of the second focal length fAy of the collimating optical system to the second focal length fBy of the focusing optical system, a desired imaging ratio my of the entrance aperture onto the detector in the non-dispersion direction y can be achieved

$$\frac{f B y}{f A y} = m y .$$

In particular, it may be provided that the second focal length fAy of the collimating optical system be greater than the second focal length fBy of the focusing optical system: fAy>fBy. This leads to a reduction in the entrance aperture in the non-dispersion direction y toward the detector. For a given detector size in the non-dispersion direction y, a larger entrance aperture can therefore be used, which is completely imaged onto the detector. This increases the optical throughput of the spectrometer (higher etendue), since more light can enter the spectrometer. It can also be provided that the second focal length fAy of the collimating optical system be smaller than the second focal length fBy of the focusing optical system: fAy<fBy. This results in an increased image of the entrance aperture onto the detector in the non-dispersion direction y.

In a further preferred embodiment of the spectrometer according to the invention, the first focal length fAx of the collimating optical system is equal to the first focal length fBx of the focusing optical system, the second focal length fAy of the collimating optical system is equal to the second focal length fBy of the focusing optical system, and the first focal length fAx of the collimating optical system is greater than the second focal length fAy of the collimating optical system: fAx=fBx>fAy=fBy. The entrance aperture is imaged here 1:1 in both the dispersion direction x (spectral dimension) and the non-dispersion direction y (spatial dimension) (fAx=fBx and fAy=fBy). Furthermore, in the non-dispersion direction y, a more compact design can be achieved (fAx>fAy).

In a further preferred embodiment of the spectrometer according to the invention, the first focal length fAx of the collimating optical system is greater than the first focal length fBx of the focusing optical system, and the second focal length fAy of the collimating optical system is equal to the second focal length fBy of the focusing optical system: fAx>fBx and fAy=fBy. Here, the entrance aperture is reduced in the dispersion direction x (spectral dimension) and imaged 1:1 in the non-dispersion direction y (spatial dimension).

Preferably, the collimating optical system and/or the focusing optical system consists of lenses, mirrors, or a combination thereof (catadioptric).

Preferably, at least one of the mirrors is a freeform mirror. The use of freeform mirrors is intended to ensure that the imaging quality from the entrance aperture to the detector is as good as possible for all occurring wavelengths.

Furthermore, other existing possibilities can also be used to improve image quality, such as knowledge of the origin and avoidance of aberrations, use of adding optical elements, use of aspherical elements, optimization of systems through ray tracing, etc.

Particularly preferred is that the collimating optical system comprise a cylindrical mirror and a freeform mirror, preferably consisting of a cylindrical mirror and a freeform mirror, and that the focusing optical system comprise two freeform mirrors, preferably consisting of two freeform mirrors. A cylindrical mirror is cheaper to manufacture than a freeform mirror. By using a cylindrical mirror in the collimating optical system, the illumination of the following freeform mirror in the non-dispersion direction is easily reduced, and the following freeform mirror in the collimating optical system then ensures good collimation of an oval beam in the direction of the dispersive element. In this way, all subsequent components can have a reduced height in the non-dispersion direction x. In this preferred embodiment, the optical power of the cylindrical mirror, however, is lower than it would be needed to completely collimate the beam in the non-dispersive direction. The beam towards the freeform mirror is less but still divergent and the freeform mirror adds the missing optical power in the non-dispersion direction to form a beam towards the dispersive optical element that is collimated in the non-dispersion directions. The advantage is that the optical power in the non-dispersive direction is split over two elements with smaller optical powers each, which generally results in better imaging qualities.

It is worth mentioning that the optical power of the cylindrical mirror/lens does not necessarily have to be chosen in a way that the beam after the cylindrical mirror is already collimated in the non-dispersion direction (focal length of the cylindrical mirror in the non-dispersion direction corresponds to the distance of the mirror to the entrance aperture). The optical power can be lower, as described above, or even larger, so that the beam behind the cylindrical mirror is convergent again and makes a footprint on the following freeform mirror that is smaller in the non-dispersion direction than the size of the cylindrical mirror in the non-dispersion direction. In this case, the optical power of the freeform mirror would have to be negative in the non-dispersion direction to achieve a collimated beam in that direction after the freeform mirror. This would result in a freeform mirror and a dispersive element with a smaller height than the cylindrical lens/mirror. As the optical power of the cylindrical lens/mirror, however, is very large in this case, there might be problems with the imaging quality.

The invention also relates to a method for manufacturing a previously described spectrometer, wherein, for the formation of the collimating optical system and the focusing optical system, the first focal length fBx of the focusing optical system is first selected such that a desired spectral range from Amin to Amax is imaged on the detector of a predetermined width with a selected dispersive element. Subsequently, by selecting the first focal length fAx of the collimating optical system, the imaging ratio mx in the dispersion direction of the entrance aperture onto the detector can be determined, which influences the spectral resolution of the spectrometer. The ratio of the first focal length fAx of the collimating optical system (A) and the first focal length fBx of the focusing optical system (B) (and thus the first focal length fAx of the collimating optical system) is therefore chosen depending upon a desired spectral resolution. If fAx>fBx, the entrance aperture is reduced in size in the dispersion direction and imaged onto the detector, thus improving the resolution (as long as sufficient image quality can be achieved). However, the larger the first focal length fAx of the collimating optical system is chosen, the larger all optical components become in the dispersion direction.

However, an increase of the optical components in the non-dispersion direction can be prevented by subsequently selecting the second focal length fAy of the collimating optical system. Preferably, the second focal length fAy of the collimating optical system is chosen to be smaller than the first focal length fAx of the collimating optical system. If fAy<fAx, then the optical elements and the dispersive element can be smaller in the non-dispersion direction than in the dispersion direction. This is only possible because—unlike with a conventional spectrometer—the focal lengths in the dispersion direction x and non-dispersion direction y can be chosen independently of each other. Finally, the imaging ratio in the non-dispersion direction can be determined by choosing the second focal length fBy of the focusing optical system. The optimal imaging ratio my=fBy/fAy depends upon the specific application. For example, if a system with a high light throughput (etendue) is to be created, a reduction in size in the non-dispersion direction is advantageous, since a larger entrance aperture in the non-dispersion direction can then be imaged onto the detector. If the light from a microscope is being spectrally examined and the magnification of the microscope is not to be changed by the following spectrometer, a 1:1 image in the non-dispersion direction is advantageous. If image structures at the entrance aperture are to be resolved with greater local resolution, an enlargement of the entrance aperture in the non-dispersion direction toward the detector can also be advantageous.

The manufacturing process also includes providing an entrance aperture in an aperture plane, providing a dispersive element for spectral splitting of light incident on the dispersive element in a dispersion direction x, and providing a detector in a detector plane.

The collimating optical system, which serves to collimate light passing through the entrance aperture along the optical axis and to direct the light onto the dispersive element, is formed by arranging at least two optical elements, wherein the collimating optical system has a first focal length fAx and a first focal plane in the dispersion direction x and a second focal length fAy and a second focal plane in a non-dispersion direction y perpendicular to it.

The focusing optical system, which serves to focus spectrally split light from the dispersive element onto the detector, is formed by arranging at least two further optical elements, wherein the focusing optical system has, perpendicular to the optical axis, in the dispersion direction x, a first focal length fBx and a first focal plane and, in the non-dispersion direction y, a second focal length fBy and a second focal plane.

The optical elements of the collimating optical system are designed and arranged relative to each other and to the entrance aperture in such a way that the first focal length fAx of the collimating optical system and the second focal length fAy of the collimating optical system differ from each other, and that the first focal plane of the collimating optical system and the second focal plane of the collimating optical system coincide with the aperture plane. The optical elements of the focusing optical system are designed and arranged relative to each other and to the detector in such a way that the first focal plane and the second focal plane of the focusing optical system coincide with the detector plane.

The present invention is based upon the creation of an optical system from at least two optical elements, wherein each of these can be a lens or a curved mirror, by skillfully selecting the optical power and shape of the optical elements and the arrangement of the optical elements, which optical system has different focal lengths in two mutually perpendicular directions (dispersion direction and non-dispersion direction), and in which the two principal planes are arranged such that the two focal planes are in the same place in the dispersion direction and non-dispersion direction. The anamorphic, and, in particular, double anamorphic, spectrometer according to the invention opens up new design possibilities through the choice of four focal lengths. In particular, the imaging ratios in the dispersion direction and in the non-dispersion direction can be set independently of each other. This allows for optimizations in the design of the spectrometer or optical throughput, which themselves have no negative impact on the desired spectral range or the desired resolution.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1a shows a possible arrangement of the components of an optical spectrometer according to the invention, as well as, by way of example, the path of three light rays of different wavelengths through the spectrometer, which enter the spectrometer perpendicularly through the center of the entrance aperture, wherein the collimating optical system comprises a cylindrical mirror and a free-form mirror, and the focusing optical system comprises two free-form mirrors.

FIG. 1b shows the distances between the optical elements and the entrance aperture and the detector, respectively, in the preferred embodiment shown in FIG. 1a.

FIGS. 2a-b schematically show the components of a collimating optical system with two optical elements and a representation of the light ray path of the light passing through the collimating optical system with a view a) in the non-dispersion direction y (view perpendicular to the x-z plane) and b) in the dispersion direction x (view perpendicular to the y-z plane).

FIGS. 3a-c schematically show the components of a spectrometer according to the invention as well as a representation of the light beam path of the light passing through the spectrometer with a view: a) in non-dispersion direction y; b) in the direction of the local dispersion direction x of the collimated light beam (perpendicular to the local y-z plane in front of the dispersive element); c) in the direction of the local dispersion direction x of the focused light beam (perpendicular to the local y-z plane after the dispersive element).

FIG. 4 shows the key steps of the inventive method for determining the focal lengths in the context of manufacturing a spectrometer according to the invention.

FIG. 5 is a table of the mirror of the collimating optical system A1 and A2.

FIG. 6 is a table of the mirror of the collimating optical system B1 and B2.

### DETAILED DESCRIPTION OF THE INVENTION AND DRAWINGS

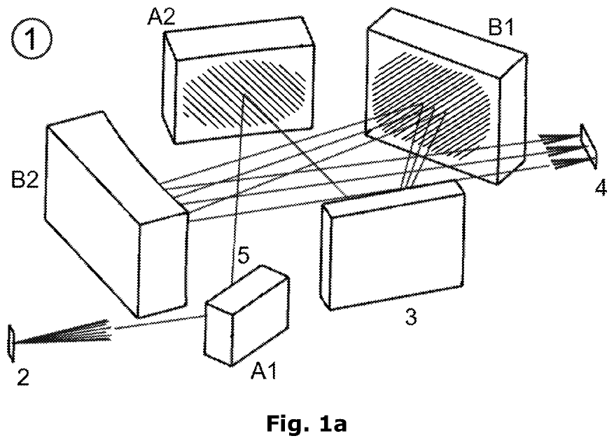

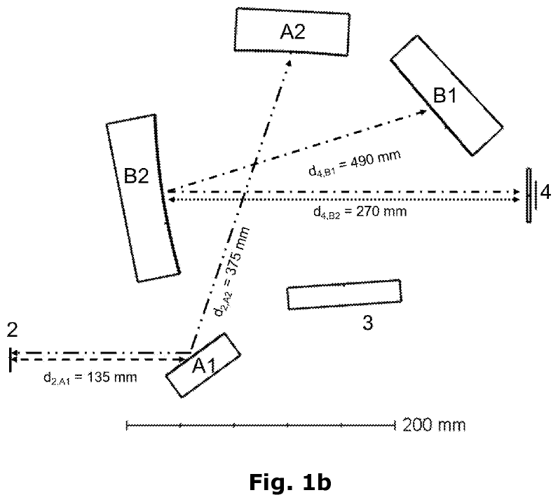

FIG. 1 a and FIG. 1b show, by way of example, a particularly preferred embodiment of the spectrometer 1 according to the invention with an entrance aperture 2, a collimating optical system A with optical elements A1, A2, a dispersive element 3, a focusing optical system B with optical elements B1, B2, and a detector 4.

For the sake of clarity, the light entering the spectrometer as a radiation cone between the optical elements A1, A2, B1, B2 has been represented only by three light rays of different wavelengths, which enter the spectrometer 1 perpendicularly through the center of the entrance aperture 2 (central beams) and take different paths to the detector after the dispersive element 3. The illumination of the entire radiation cone entering spectrometer 1 is shown as a hatched region on the surfaces of mirrors A2 and B1.

The central beam with the wavelength λz, which reaches the center of the detector 4, defines the optical axis 5 and the local propagation direction z of the light between the optical elements.

The entrance aperture 2 can, for example, be designed as a slit. To keep the width of the image of the entrance aperture 2 small, a slit is usually used as the entrance aperture 2, the width of which is typically on the order of a few micrometers to 1 millimeter. The height of the gap, however, can be greater and is usually a few millimeters. Alternatively, a fiber end or an arrangement of several fiber ends, e.g., arranged one above the other, can be used as the entrance aperture 2.

FIG. 1a shows how three central rays of different wavelengths are first directed from the entrance aperture 2 via the optical element A1 and via the optical element A2 to the dispersive element 3. Behind the dispersive element 3, the three central beams of different wavelengths continue their path in different directions and are directed via the elements B1 and then B2 to different locations of the detector 4.

The entire cone of light entering the spectrometer surrounds the central rays. The incoming light is collimated by the collimating optical system A and directed onto the dispersive element 3 (e.g., a transmission grating, reflection grating, prism). From the dispersive element 3, the different wavelengths λ of the collimated light beam are deflected to varying degrees in the dispersion direction x. The focusing optical system B absorbs this light and focuses light of different wavelengths λ onto different points of the detector D. The dispersive element 3 acts as a system aperture (aperture stop), which limits the radiation striking the focusing optical system B. Overall, for each wavelength λ, an image of the entrance aperture 2 is created on the detector 4.

In the specific embodiment of the spectrometer 1 according to the invention shown in FIG. 1 a and FIG. 1b, the collimating optical system A comprises a cylindrical mirror (optical element A1) and a freeform mirror (optical element A2); the focusing optical system B comprises two freeform mirrors (optical elements B1, B2). By using the cylindrical mirror A1, the homogeneous radiation cone passing through the entrance aperture 2 is narrowed in the non-dispersion direction y, so that the elements following the cylindrical mirror A1 (more dispersed element 3 and optical elements A1 B1, B2) can be made more compact in the non-dispersion direction y.

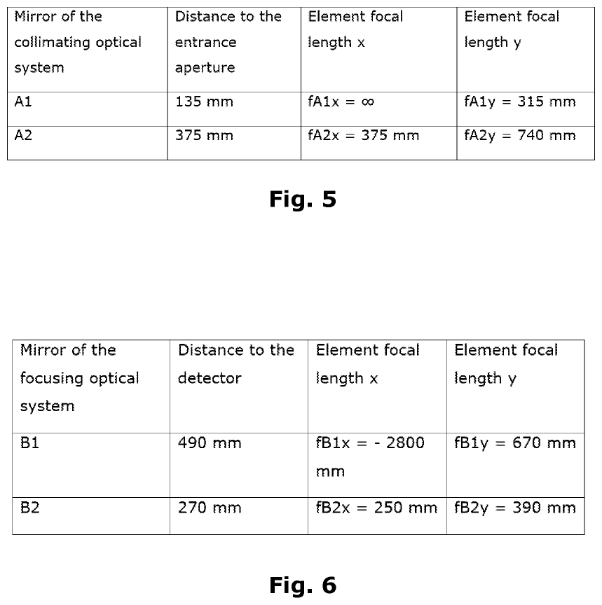

FIG. 1b shows the distances between the optical elements A1 and A2 and the entrance aperture 2, as well as the distances between the optical elements B1 and B2 and the detector 4, as used in the specific example shown in FIG. 1a. The individual optical elements A1, A2, B1, B2 each have a first element focal length fA1x, fA2x and, in a direction y perpendicular to this and in a non-dispersive direction, a second element focal length fA1y, fA2y. The element focal lengths fA1x, fA2x, fB1x, fB2x of the optical elements A1, A2, B1, B2, as well as the distances mentioned above, are summarized in the tables shown in FIGS. 5 and 6.

In the example as shown in the tables, the second element focal lengths fA1y and fA2y of both mirror A1 and mirror A2 are finite, so that the optical power of the collimating optical system A in the non-dispersion direction y is distributed between the two optical elements A1 and A2. The first element focal length fB1x of mirror B2 of the focusing optical system B is negative in this example. This was chosen so that the illumination of mirror B2 in the dispersion direction is such that mirror B2 subsequently enables telecentric focusing for all wavelengths λ onto the detector 4, i.e., that the central rays of each wavelength incident on the detector are perpendicular to it.

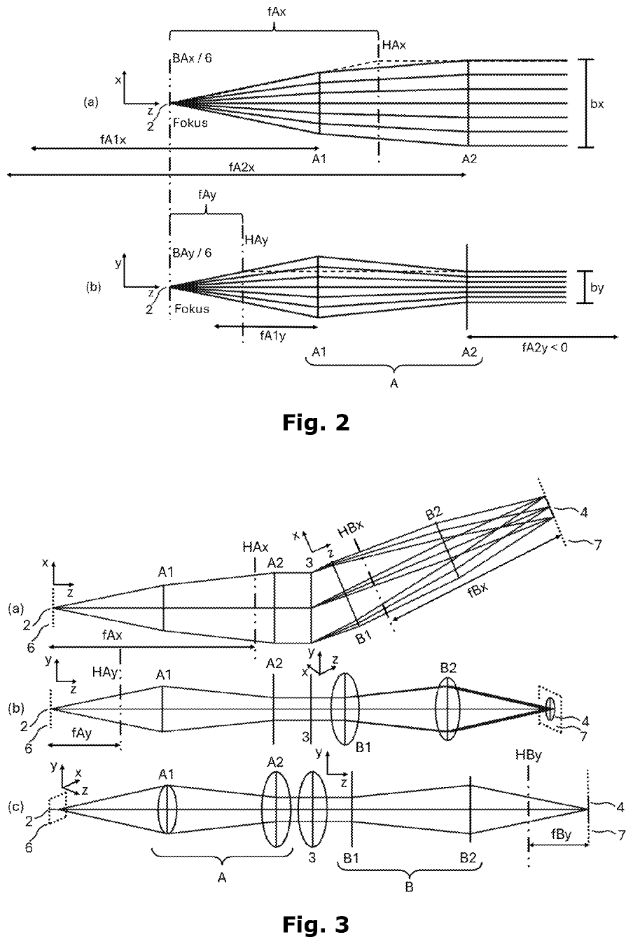

FIG. 2a and FIG. 2b show the path of the light rays, running along the local propagation direction z, from the entrance aperture 2 arranged in an aperture plane 6 to the exit point of the collimating optical system A in the dispersion direction x and in the non-dispersion direction y. The light leaves the entrance aperture 2 in a homogeneous radiation cone, which is determined by a certain F-number (F/#) or numerical aperture, strikes the optical elements A1, A2 of the collimating optical system A, and is collimated by it. The collimating optical system A, according to the invention, has, in a (local) dispersion direction x, a first focal length fAx and a first focal plane BAx and, in a non-dispersion direction y, a second focal length fAy and a second focal plane BAy, wherein the focal lengths fAx, fAy differ from each other. The collimating optical system A is therefore an anamorphic optical system. Accordingly, the collimating optical system A also has two different principal planes HAx, HAy in the dispersion direction x and in the non-dispersion direction y. The element focal lengths fA1x, fA1y, fA2x, fA2y of the two optical elements A1, A2 of the collimating optical system A are chosen and aligned such that both the focal plane BAx in the dispersion direction and the focal plane BAy in the non-dispersion direction y lie in the aperture plane 6 and the focal points in the dispersion direction x and non-dispersion direction y coincide, so that the light beam, which comes conically and homogeneously in the dispersion direction x and non-dispersion direction y from a focal point (focal point of the collimating optical system A), is collimated behind the collimating optical system A in the dispersion direction x and non-dispersion direction y. In this way, a collimated light beam with different width bx in dispersion direction x (FIG. 2a) and width by in non-dispersion direction y (FIG. 2b) is produced.

In the present case, the width by in the non-dispersion direction is smaller than width bx in the dispersion direction x, since the first focal length fx in the dispersion direction x is greater than the second focal length fy in the non-dispersion direction y. The use of such a collimating optical system, shown in FIG. 2, in a spectrometer 1 leads to a low height of the dispersive element 3 and the optical elements A2, B1, B2 in the non-dispersion direction y and thus to a more compact spectrometer 1, without negatively affecting the etendue (light throughput) of the spectrometer.

The entire path of the light beam through the spectrometer 1 is shown in FIG. 3a-FIG. 3c. FIGS. 3a-3c show the light beam from different viewing directions. The Cartesian coordinate system xyz refers to the optical axis 5. The local z-axis therefore always points in the direction of the central beam (local propagation direction) which is imaged onto the center of the detector (central beam with central wavelength λz). The local dispersion direction x is perpendicular to the local propagation direction z and the non-dispersion direction y. When the light beam is deflected (e.g., by optical elements A1, A2, B1, B2 or by the dispersive element 3) and when the local propagation direction z of the central beam with the central wavelength λz changes accordingly, the local dispersion direction x also changes, as shown in FIG. 3a-FIG. 3c. That is to say, the coordinate system xyz changes relative to the optical elements A1, A2, B1, B2 and to the dispersive element 3.

The spectrometer 1 comprises a collimating optical system as shown in FIG. 2, followed by a dispersive optical element 3 and a focusing optical system B.

The focusing optical system B, in the embodiment shown in FIGS. 3a-3c, has, in the dispersion direction x, a first focal length fBx and a first focal plane BBx and, in a non-dispersion direction y, a second focal length fBy and a second focal plane BBy, wherein the focal lengths fBx and fBy differ from each other. The focusing optical system B is therefore also an anamorphic optical system. Accordingly, the focusing optical system B also has two different principal planes HBx, HBy in the dispersion direction x and in the non-dispersion direction y. The detector 4 is located in a detector plane 7. The focusing optical system B comprises at least two optical elements B1, B2, whose focal lengths fB1x, fB1y, fB2x, and fB2y are chosen and coordinated such that both the focal plane BBx in the dispersion direction and the focal plane BBy in the non-dispersion direction lie in the detector plane 7 and the focal points in the dispersion direction x and non-dispersion direction y coincide, so that the light beam, which enters the focusing optical system B in collimation, is focused behind the focusing optical system B in the detector plane 7.

The anamorphic/double-anamorphic design of the optical systems A, B of spectrometer 1 allows the height of spectrometer 1 to be reduced. However, reducing the height of the optical elements in the non-dispersion direction does not in any way restrict the light cone entering through the entrance aperture 2. It remains completely intact, and all the light finds its way to the detector. The entrance cone is characterized by a homogeneous numerical aperture NA or by a homogeneous F-number (F/#). The collimating optical system A is also adapted to this homogeneous F-number, because F/#=fAx/bx=FAy/by (cf. FIG. 2).

The spectrometer 1 according to the invention is characterized by four focal lengths fAx, fAy, fBx, fBy. By using two anamorphic mirror/lens systems, viz., one for the collimating optical system A and one for the focusing optical system B, the manufacture of the spectrometer 1 according to the invention provides additional degrees of freedom with regard to the choice of the four focal lengths fAx, fAy, fBx, fBy. By choosing the first focal lengths fBx and fAx (in the dispersion direction), the magnification of the image of the entrance aperture 2 on the detector 4 is defined in the dispersion direction x (spectral dimension), and by choosing the second focal lengths fBy and fAy, the magnification of the image of the entrance aperture 2 on the detector 4 is defined in the non-dispersion direction y (spatial dimension). Furthermore, the first focal length fBx of the focusing optical system determines, when using a dispersive element 3 with a given dispersion strength (groove density in the grating, dispersion in the prism) and a detector 4 with a given size in the dispersion direction, which spectral range of Amin to Amax is accessible in one measurement. The first focal length fAx of the collimating optical system largely determines the size of the following optical elements B1, B2 and the dispersive element 3 in the dispersion direction, and the second focal length fAy of the collimating optical system largely determines the size of the following optical elements B1, B2 and the dispersive element 3 in the non-dispersion direction.

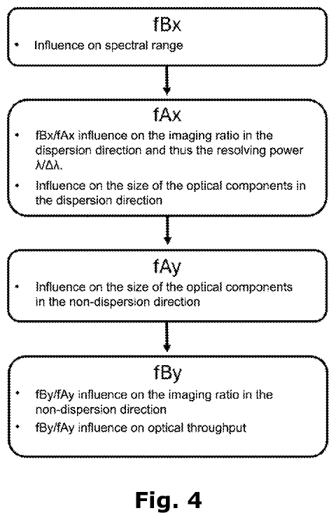

In FIG. 4, it is shown how the focal lengths of the collimating optical system A and the focusing optical system B are determined in the context of the manufacture of the spectrometer 1 according to the invention. First, the first focal length fBx of the focusing optical system B is chosen depending upon the minimum wavelength λmin and maximum wavelength λmax to be detected on the detector 4. The first focal length fBx of the focusing optical system B is preferably chosen such that, for a given detector 4 with a given width and a chosen dispersive element 3 with a given dispersion strength, a desired spectral range from λmin to λmax is completely imaged onto the detector 4, and a complete spectrum (i.e., in one measurement without rotation of the dispersive element 3) can be recorded.

Once the first focal length fBx of the focusing optical system B is determined, the first focal length fAx of the collimating optical system A is then determined. The ratio fBx/fAx determines the width of the image of the entrance aperture 2 on the detector 4 in the dispersion direction and thus has a direct influence on the spectral resolution power λ/Δλ. Typically, a 1:1 imaging is chosen where fAx=fBx. To reduce the imaging size of the entrance aperture 2 on the detector 4 (and thus improve the resolution), a focal length fAx of the collimating optical system A would be necessary that is larger than the focal length fBx of the focusing optical system B (fAx>fBx). This is advantageous for the spectral resolution (as long as a sufficiently good image quality of the reduced image can be achieved), but it also enlarges the optical components in the dispersion direction x.

The second focal lengths fAy, fBy of the collimating optical system A and the focusing optical system B are chosen independently of the first focal length fAx of the collimating optical system A and independently of the first focal length fBx of the focusing optical system B.

First, the focal length fAy is selected, which has a direct influence on the size of the optical elements A2, B1, B2 and the dispersive element 3 in the non-dispersion direction y. A small second focal length fAy of the collimating optical system A is therefore advantageous here. After selecting the second focal length fAy of the collimating optical system A, the second focal length fBy of the focusing optical system B is selected. The ratio fBy/fAy then determines the imaging ratio of the entrance aperture 2 onto the detector 4 in the non-dispersion direction y. The optimal imaging ratio depends entirely upon the specific application for which the spectrometer 1 is to be used. For example, if the light from an upstream optical system such as a microscope is to be spectrally analyzed and the magnification of the microscope is not to be changed by the spectrometer, a 1:1 image is chosen in the non-dispersion direction. If, on the other hand, the optical throughput is to be as large as possible and therefore the largest possible entrance aperture is to be imaged onto the detector, then a reduction with fBy<fAy is advantageous. Magnification can be advantageous when fine structures within the entrance aperture 2 need to be spatially resolved.

The spectrometer 1 according to the invention preferably comprises an anamorphic collimating optical system A and an anamorphic focusing optical system B, which in the general case makes the overall system an anamorphic system (double-anamorphic) in which the imaging of the entrance aperture 2 onto the detector 4 has different magnifications in the dispersion direction x and non-dispersion direction y. In a special embodiment of the invention, an anamorphic image can also be realized if only the collimating optical system A is anamorphic. In addition, the special case covered by the present invention is that both the collimating optical system A and the focusing optical system B are anamorphic, but, overall, the same magnifications result for the spectrometer 1 in the dispersion direction x and in the non-dispersion direction y. The overall system is then no longer anamorphic, but still has advantages over prior art systems. This happens, for example, when fBx=c*FBy and FAx=c*FAy. If the constant c is >1, then fAx>Fay, and the height of the spectrometer is reduced in the non-dispersion direction. At the same time, the imaging ratios in dispersion and non-dispersion directions are given by fBx/fAx=(c*fBy)/(c*fAy)=FBy/FAy. The imaging ratios are therefore the same in both dispersion and non-dispersion directions, yet the height of the spectrometer can be reduced.

In the following, using an exemplary embodiment of the spectrometer 1 according to the invention, as shown in FIG. 1a and FIG. 1b, it will be shown how different focal lengths within the collimating optical system A quantitatively affect the height of the spectrometer. The exemplary embodiment shows a spectrometer 1 with good resolution and compact design, in which the image is intended to be a 1:1 image due to the later use of the spectrometer 1 in the non-dispersion direction y. In the exemplary embodiment, the collimating optical system A with the cylindrical mirror A1 and the freeform mirror A2 has a first focal length fAx=375 mm and a second focal length fAy=264 mm. The focusing optical system with the two freeform mirrors B1, B2 has a first focal length fBx=264 mm and a second focal length fBy=264 mm. The parameters of the freeform mirrors A2, B1, B2 were adapted so that a sharp image can be generated over the entire detector area. The spectrometer 1 images the entrance aperture 2 in the non-dispersion direction y 1:1. In the dispersion direction x, a reduction in mx=264/375≈0.7 is produced, which improves the spectral resolution compared to a 1:1 imaging. The first focal length fBx=264 mm of the focusing optical system B was chosen such that, with a grating serving as dispersive element 3 with a groove density of 600 lines/mm and a specific grating position (angle of incidence of the radiation on the grating), a spectral range from λ=533 nm to λ=680 nm is imaged on a detector with a detector width of 26.4 mm. Rotating the grating allows access to other spectral ranges. In the embodiment of the spectrometer 1 according to the invention described here, the measured spectral lines are narrower by a factor of 0.7 than in a spectrometer that produces a pure 1:1 image. The height of the entrance aperture 2 is imaged to the detector 4 in a 1:1 ratio by choosing fAy=fBy=264 mm. At the same time, the choice of the second focal length fAy=264 mm<375 mm of the collimating optical system A in the non-dispersion direction y, which is smaller than the first focal length fAx of the collimating optical system A in the dispersion direction x, ensures that the optical elements A2, B1, B2 and the dispersive element 3 in the non-dispersion direction y can be much smaller than, for example, in a known spectrometer, which would have a uniform focal length of fA=375 mm on the input side and a focal length of fB=264 mm on the output side. In the latter case, the focal length fA=375 mm and the numerical aperture NA=0.1 would result, for example, in a grating height of at least 2*375 mm*tan(arcsin(0.1))=75 mm. In contrast, in the embodiment of the spectrometer according to the invention described here, a required grating height of 2*264 mm*tan(arcsin(0.1))=53 mm results. The grating height can therefore be reduced by approximately 30%. The height of the freeform mirrors A2, B1, and B2 can also be chosen to be correspondingly smaller than in conventional spectrometers. The example described makes it clear that, with the spectrometer according to the invention, a significant saving of installation space and thus also a significant cost saving can be achieved. A conventional spectrometer with a uniform input focal length of fA=375 mm and a uniform output focal length of fB=264 mm would have the same spectral properties compared to the exemplary embodiment of the spectrometer according to the invention, but would also have a reduction in the size of the entrance aperture 2 in the non-dispersion direction on the detector 4, in addition to the larger design.

### LIST OF REFERENCE SIGNS

1 spectrometer
2 entrance aperture
3 dispersive element
4 detector
5 optical axis
6 aperture plane
7 detector plane
A collimating optical system
A1, A2 optical elements of the collimating optical system
BAx first focal plane of the collimating optical system (in dispersion direction x)
BAy second focal plane of the collimating optical system (in the non-dispersion direction y)
fAx first focal length of the collimating optical system (in dispersion direction x)
fAy second focal length of the collimating optical system (in the non-dispersion direction y)
fA1x first element focal length of the optical element A1 (focal length of the optical element A1 in dispersion direction x)
fA1y second element focal length of the optical element A1 (second focal length of element A1 in non-dispersion direction y)
fA1x first element focal length of the optical element A2 (first focal length of element A2 in dispersion direction x)
fA1y second element focal length of the optical element A2 (second focal length of element A2 in non-dispersion direction y)
HAx first principal plane of the collimating optical system
HAy second principal plane of the collimating optical system
B focusing optical system
B1, B2 optical elements of the focusing optical system
BBx first focal plane of the focusing optical system
BBy second focal plane of the focusing optical system
fBx first focal length of the focusing optical system (in dispersion direction x)
fBy second focal length of the focusing optical system (in the non-dispersion direction y)
fB1x first element focal length of the optical element B1 (focal length of the optical element B1 in dispersion direction x)
fB1y second element focal length of the optical element B1 (second focal length of element B1 in non-dispersion direction y)
fB1x first element focal length of the optical element B2 (first focal length of element B2 in dispersion direction x)
fB1y second element focal length of the optical element B2 (second focal length of element B2 in non-dispersion direction y)
HBx first principal plane of the focusing optical system
HBy second principal plane of the focusing optical system
x local dispersion direction (direction in which a splitting occurs/exists due to the dispersive element)
y non-dispersion direction is perpendicular to the dispersion direction
z direction of propagation of the central beam with the wavelength, which reaches the center of the detector after passing through the spectrometer.

### LITERATURE LIST

[US659] U.S. Pat. No. 8,773,659B2
[US807] US2005264807A1
[US088] US2009103088A1
[US772] US2006082772A1
[US140] U.S. Pat. No. 6,266,140B1
[US413] U.S. Ser. No. 10/962,413B2
[WO584] WO 2021/255584 A1

What is claimed is:

1. An optical spectrometer with an optical axis, comprising:
an entrance aperture configured for limiting light entering the spectrometer along the optical axis, wherein the entrance aperture is arranged in an aperture plane that is perpendicular to the optical axis;
a collimating optical system with at least two optical elements configured for collimating the light passing through the entrance aperture, wherein the collimating optical system has, perpendicular to the optical axis, in a dispersion direction x, a first focal length and a first focal plane and, in a non-dispersion direction y perpendicular thereto, a second focal length and a second focal plane;
a dispersive element configured for spectral splitting in the dispersion direction x of light incident on the dispersive element;
a focusing optical system configured for focusing the light spectrally split by the dispersive element, wherein the focusing optical system has, perpendicular to the optical axis, in the dispersion direction x, a first focal length and a first focal plane and, in the non-dispersion direction y, a second focal length and a second focal plane;
a detector configured for detecting the focused light in a detector plane;
wherein the first focal length of the collimating optical system and the second focal length of the collimating optical system differ from each other; and
wherein the first focal plane of the collimating optical system and the second focal plane of the collimating optical system coincide with the aperture plane;
wherein the optical elements have a first element focal length in a dispersion direction x perpendicular to the optical axis, and a second element focal length in a non-dispersion direction y perpendicular thereto;
wherein both the first element focal length and the second element focal length of at least one of the optical elements of the collimating optical system are finite and differ from one another.

2. The spectrometer according to claim 1, wherein the first focal length of the collimating optical system is greater than the second focal length of the collimating optical system.

3. The spectrometer according to claim 1, wherein the first focal length of the collimating optical system is greater than the second focal length of the collimating optical system multiplied by 1.1.

4. The spectrometer according to claim 1, wherein the focusing optical system comprises at least two optical elements, wherein the first focal length of the focusing optical system and the second focal length of the focusing optical system differ from each other, and wherein the first focal plane and the second focal plane of the focusing optical system coincide with the detector plane.

5. The spectrometer according to claim 1, wherein the first focal length of the collimating optical system is greater than or equal to the first focal length of the focusing optical system.

6. The spectrometer according to claim 1, wherein the second focal length of the collimating optical system is equal to the second focal length of the focusing optical system.

7. The spectrometer according to claim 1, wherein the second focal length of the collimating optical system is greater than the second focal length of the focusing optical system.

8. The spectrometer according to claim 1, wherein the first focal length of the collimating optical system is equal to the first focal length of the focusing optical system, wherein the second focal length of the collimating optical system is equal to the second focal length of the focusing optical system, and wherein the first focal length of the collimating optical system is greater than the second focal length of the collimating optical system.

9. The spectrometer according to claim 1, wherein the first focal length of the collimating optical system is greater than the first focal length of the focusing optical system, and wherein the second focal length of the collimating optical system is equal to the second focal length of the focusing optical system.

10. The spectrometer according to claim 1, wherein the collimating optical system and/or the focusing optical system consists of lenses, mirrors, or a combination thereof (catadioptric).

11. The spectrometer according to claim 10, wherein at least one of the mirrors is a freeform mirror.

12. The spectrometer according to claim 11, wherein the collimating optical system comprises a cylindrical mirror and a freeform mirror, and wherein the focusing optical system comprises two freeform mirrors.

13. A method for manufacturing the spectrometer according to claim 1, wherein, for forming the collimating optical system and the focusing optical system:
first choosing the first focal length of the focusing optical system wherein, with the dispersive element, a desired spectral range of λₘᵢₙ to λₘₐₓ is imaged on the detector of a predetermined width; and,
then choosing the ratio of the first focal length of the collimating optical system and the first focal length of the focusing optical system depending upon a desired spectral resolution.

14. The method according to claim 13, wherein the second focal length of the collimating optical system is selected to be smaller than the first focal length of the collimating optical system.
